(19) United States
(12) Patent Application Publication
(10) Pub. No.: US 2020/0067222 A1
(43) Pub. Date: Feb. 27, 2020

(54) TERMINAL AND METHOD FOR PRODUCING TERMINAL

(71) Applicant: DAI-ICHI SEIKO CO., LTD., Kyoto-shi (JP)

(72) Inventors: Takayoshi Endo, Shizuoka-shi (JP); Shuji Touno, Shizuoka-shi (JP); Hiroyuki Kurita, Shizuoka-shi (JP)

(21) Appl. No.: 16/533,431

(22) Filed: Aug. 6, 2019

(30) Foreign Application Priority Data
Aug. 24, 2018 (JP) 2018-157823

(51) Int. Cl. H01R 13/05; H01R 43/16

(52) U.S. Cl. CPC H01R 13/052; H01R 43/16

(57) ABSTRACT

A terminal has a central axis parallel to a direction in which the terminal is inserted into a mating terminal and includes a contact part and an intermediate part. The contact part includes: four springs that make contact with the mating terminal and are equally spaced along a circumferential direction around the central axis; and a joint part that makes the four springs join together, the contact part being formed by bending a first electrically conductive plate. The intermediate part includes a tubular part, and is disposed adjacent to the contact part and formed by bending a second electrically conductive plate. The plate thickness of a spring forming portion of the first electrically conductive plate, the spring forming portion forming the springs, is smaller than the plate thickness of a tubular part forming portion of the second electrically conductive plate, the tubular part forming portion forming the tubular part.

### CROSS-REFERENCE TO RELATED APPLICATION

This application claims priority to Japanese Patent Application No. 2018-157823, filed on Aug. 24, 2018, the entire disclosure of which is incorporated by reference herein.

### FIELD

This application relates generally to a terminal and a method for producing a terminal.

### BACKGROUND

Examined Japanese Patent Application Publication No. S60-30071 discloses a terminal to be electrically connected to a mating terminal, which is a tubular seamless pipe. The terminal described in Examined Japanese Patent Application Publication No. S60-30071 includes a middle sleeve, a probe with a pair of arms extending in the longitudinal direction from one end of the middle sleeve, and an attaching portion disposed at the other end of the middle sleeve.

The terminal described in Examined Japanese Patent Application Publication No. S60-30071 is problematic in that it is difficult to adjust the contact load of the probe on the seamless pipe, and thus the terminal makes contact with the mating terminal with lower reliability.

The present disclosure has been made in view of the foregoing circumstances, and an objective of the disclosure is to improve the reliability with which the terminal makes contact with the mating terminal.

### SUMMARY

To achieve the above-described objective, a terminal according to a first aspect of the present disclosure is:

a terminal having a central axis parallel to a direction in which the terminal is inserted into a mating terminal, the terminal including:

a contact part including: a plurality of springs that makes contact with the mating terminal and are equally spaced along a circumferential direction around the central axis; and a first joint part that makes the plurality of the springs join together, the contact part being formed by bending a first electrically conductive plate; and

a body part including a tubular part formed to be tubular, the body part being disposed adjacent to the contact part and formed by bending a second electrically conductive plate,

wherein a plate thickness of a spring forming portion of the first electrically conductive plate, the spring forming portion forming the springs, is smaller than the plate thickness of a tubular part forming portion of the second electrically conductive plate, the tubular part forming portion forming the tubular part.

The contact part may include a second joint part that makes the plurality of the springs join together at an insertion side to be inserted into the mating terminal, and

the first joint part makes the plurality of the springs join together at a side opposite to the insertion side.

The plate thicknesses of a first joint part forming portion forming the first joint part and a second joint part forming portion forming the second joint part in the first electrically conductive plate may be smaller than the plate thickness of the second electrically conducive plate.

The body part may include a connection part connecting the tubular part and the first joint part forming portion, and

a connection part forming portion forming the connection part in the second electrically conductive plate may be formed such that the plate thickness of the connection part forming portion becomes gradually smaller toward the first joint part forming portion.

The plate thicknesses of a first joint part forming portion forming the first joint part and a second joint part forming portion forming the second joint part in the first electrically conductive plate may be equal to the plate thickness of the second electrically conducive plate.

The terminal may include a conductor fixing part that is formed by bending a third electrically conductive plate and is to be connected to a conductor to bring the conductor into electrical conduction with the mating terminal, and

the plate thickness of the spring forming portion may be smaller than the plate thickness of the third electrically conductive plate.

The terminal may include an insertion tip part disposed adjacent to the contact part at an insertion side to be inserted into the mating terminal, the insertion tip part being formed by bending a fourth electrically conductive plate.

The plate thickness of the fourth electrically conductive plate may be smaller than the plate thickness of the second electrically conductive plate.

The plate thickness of the fourth electrically conductive plate may be equal to the plate thickness of the second electrically conductive plate.

The insertion tip part may include a core rod extending inside the plurality of the springs.

The first electrically conductive plate and the second electrically conductive plate may be formed of a single plate.

The spring may be formed such that both ends of the spring are thinner than a central portion of the spring with respect to the circumferential direction.

The spring may include an inner surface disposed to face the central axis, and the inner surface may be formed into a flat surface.

The spring may include an inner surface disposed to face the central axis, and the inner surface may be formed into a convex surface partly expanding.

The spring may include an inner surface disposed to face the central axis, and the inner surface may be formed into a concave surface partly dented.

The spring may include an outer surface that is disposed on a side opposite to the inner surface and formed into a curved surface expanding outward from the contact part and having a first curvature, and

the inner surface may be formed into a curved surface having a second curvature representing a less steeper curve than the first curvature.

The spring may be formed such that both ends of the spring are thinner than a central portion of the spring with respect to a direction in which the central axis extends.

The body part may include a cantilevered lance extending from the tubular part.

The tubular part may be formed by winding the second electrically conductive plate into a square-shaped tube.

A method for producing a terminal according to a second aspect of the present disclosure is:

a method for producing a terminal having a central axis parallel to a direction in which the terminal is inserted into a mating terminal, the terminal including: a contact part including a plurality of springs that makes contact with the mating terminal and are equally spaced along a circumferential direction around the central axis, the contact part being formed by bending a first electrically conductive plate; and a body part including a tubular part formed to be tubular, the body part being disposed adjacent to the contact part and formed by bending a second electrically conductive plate,

the method including the steps of:
preparing a plate having a plate thickness equal to the plate thickness of the second electrically conductive plate;
forming the first electrically conductive plate by decreasing the plate thickness of a spring forming portion of the plate, the spring forming portion forming the spring; and
forming the contact part by bending the first electrically conductive plate.

According to the present disclosure, the plate thickness of a spring forming portion of the first electrically conductive plate, the spring forming portion forming the springs, is smaller than the plate thickness of a tubular part forming portion of the second electrically conductive plate, the tubular part forming portion forming the tubular part. Hence, a spring force of the spring can be easily adjusted. As a result, the terminal can make contact with the mating terminal with higher reliability.

### BRIEF DESCRIPTION OF THE DRAWINGS

A more complete understanding of this application can be obtained when the following detailed description is considered in conjunction with the following drawings, in which:

FIG. 1 is a perspective view of a terminal and a mating terminal according to Embodiment 1;

FIG. 2 is a perspective view of the terminal;

FIG. 3A is a plan view of the terminal;

FIG. 3B is a side view of the terminal;

FIG. 3C is an XZ cross-sectional view of a contact part taken along the line C-C in FIG. 3B;

FIG. 4A is a plan view of an electrically conductive plate forming the terminal;

FIG. 4B is a side view of the electrically conductive plate forming the terminal;

FIG. 5 is a cross-sectional view taken along the line V-V in FIG. 3C;

FIG. 6 is a perspective view of an intermediate part;

FIG. 7A is a plan view of an electrically conductive plate forming a terminal according to Embodiment 2;

FIG. 7B is a side view of the electrically conductive plate forming the terminal according to Embodiment 2;

FIG. 8A is a side view of a terminal according to Embodiment 3;

FIG. 8B is a cross-sectional view taken along the line B-B in FIG. 8A;

FIG. 9 is a perspective view of an electrically conductive plate forming the terminal according to Embodiment 3;

FIG. 10A is an XZ cross-sectional view of a contact part according to Embodiment 4;

FIG. 10B is an XZ cross-sectional view of a contact part according to Embodiment 5;

FIG. 10C is an XZ cross-sectional view of a contact part according to Embodiment 6; and

FIG. 11 is a plan view of an electrically conductive plate forming a terminal according to Embodiment 7.

### DETAILED DESCRIPTION

### Embodiment 1

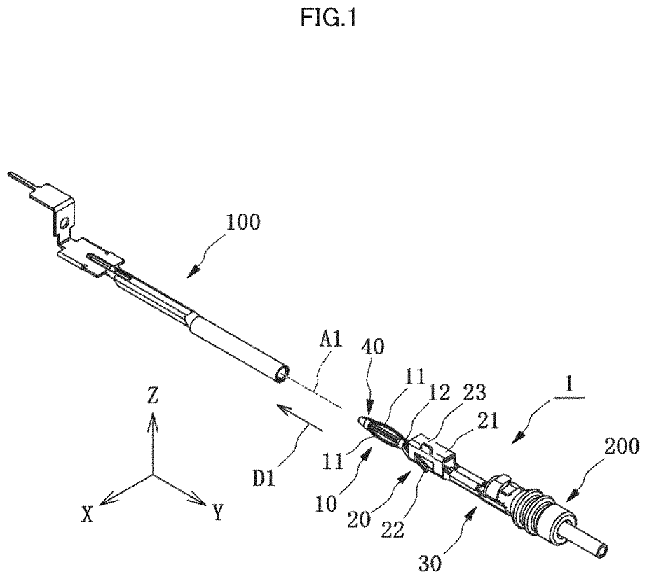

A terminal 1 according to Embodiment 1 of the present disclosure will now be described with reference to FIGS. 1 to 6. For ease of understanding, XYZ coordinates are applied to the figures and referred to as appropriate. As shown in FIG. 1, the Y-axis direction in the XYZ coordinates is parallel to the insertion direction D1 in which the terminal 1 is inserted into a mating terminal 100. The X-axis direction and the Z-axis direction are orthogonal to the insertion direction D1.

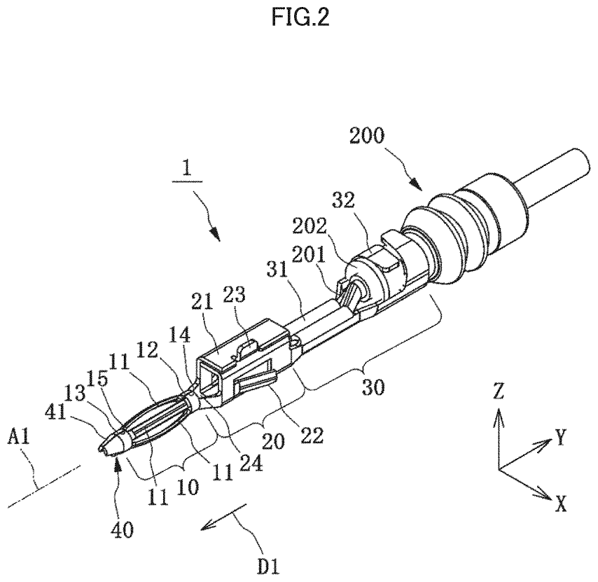

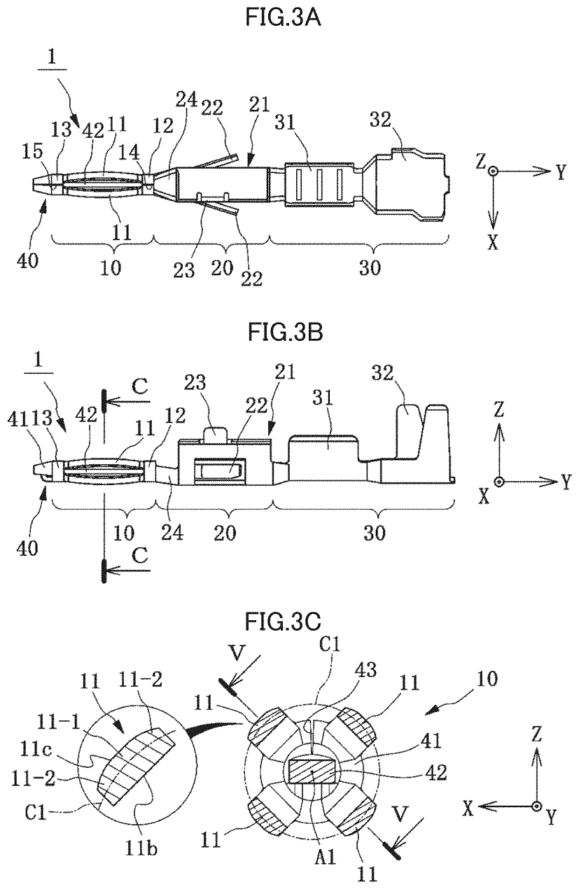

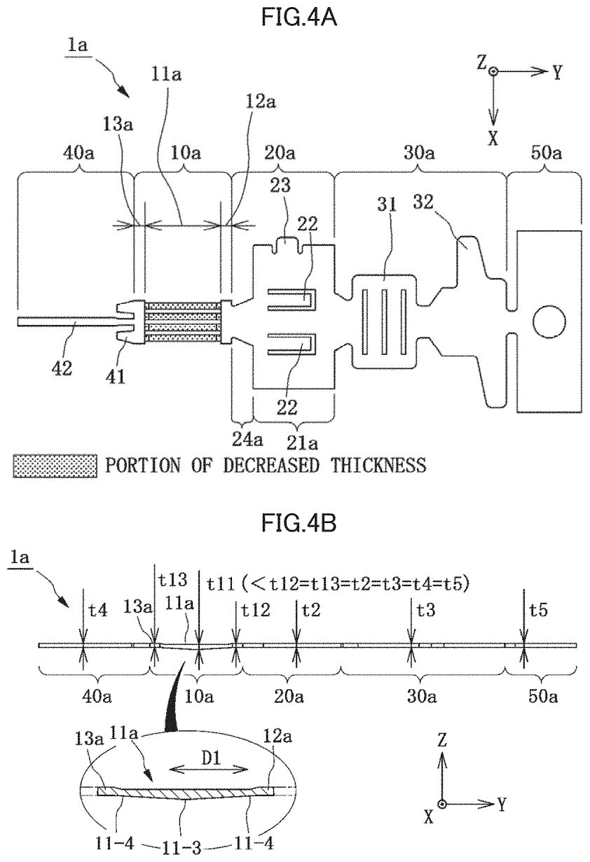

The terminal 1, which has a central axis A1 parallel to the insertion direction D1 to the mating terminal 100, is used for a connector for, for example, electronic circuit components installed in an automobile. As illustrated in FIGS. 2 and 3A to 3C, the terminal 1 includes a contact part 10, an intermediate part 20 (body part), a crimp part 30 (conductor fixing part), and an insertion tip part 40. As shown in FIGS. 4A and 4B, the terminal 1 is formed by bending an electrically conductive plate 1a.

The plate 1a is made up of first to fourth electrically conductive plates 10a to 40a and a carrier 50a. As illustrated in FIGS. 3A to 3C, 4A, and 4B, the first electrically conductive plate 10a, which is a portion forming the contact part 10, includes a spring forming portion 11a, which forms a spring 11 described below, and joint part forming portions 12a and 13a, which form joint parts 12 and 13. The second electrically conductive plate 20a, which is a portion forming the intermediate part 20, includes a tubular part forming portion 21a, which forms a tubular part 21 described below, and a connection part forming portion 24a, which forms a connection part 24. The third electrically conductive plate 30a is a portion forming the crimp part 30. The fourth electrically conductive plate 40a is a portion forming the insertion tip part 40. The plate thickness t5 of the carrier 50a may be of any size but is preferably equal to the plate thickness t3 of the adjacent third electrically conductive plate 30a. In Embodiment 1, the plate 1a has a plate thickness of 0.2 mm except the spring forming portion 11a.

The contact part 10 is formed by bending the first electrically conductive plate 10a. The plate thickness t11 of the spring forming portion 11a in the first electrically conductive plate 10a is smaller than t2 and t3, which are the plate thicknesses of the second electrically conductive plate 20a and the plate thickness of the third electrically conductive plate 30a, respectively. Note that the plate thickness t11 of the spring forming portion 11a in the first electrically conductive plate 10a is not uniform but is rather a mixture representing thicker portions and thinner portions and thus uneven and varied. In Embodiment 1, the plate thickness t11 is 0.15 to 0.18 mm, for example. The plate thicknesses t2 and t3 are each 0.2 mm, for example. In addition, the plate thicknesses t12 and t13 of the joint part forming portions 12a and 13a in the first electrically conductive plate 10a are equal to the plate thicknesses t2 and t3 of the second electrically conductive plate 20a and the third electrically plate 30a, respectively. In Embodiment 1, the plate thicknesses t12 and t13 are each 0.2 mm, for example. As illustrated in FIGS. 2 and 3A to 3C, the contact part 10 includes a plurality of the springs 11 to make contact with the mating terminal 100 (see FIG. 1) and the joint parts 12 and 13 making the springs 11 join together on both the +Y and the −Y sides.

The springs 11, the number of which is four, have resilience and are equally spaced along a circumferential direction C1 around the central axis A1 (see FIG. 3C). The spring 11 is formed so as to expand in a direction orthogonal to the central axis A1. The spring 11 makes contact with the mating terminal 100 (see FIG. 1) while flexibly bending based on resilience of the spring.

As illustrated in FIG. 3C, the spring 11 is formed such that both ends 11-2 are thinner than a central portion 11-1 with respect to the circumferential direction C1. For example, in Embodiment 1, the central portion 11-1 has a plate thickness of about 0.18 mm while the both ends 11-2 have a plate thickness of about 0.15 mm. The spring 11 is formed into a shape having an inner surface 11b and an outer surface 11c. The inner surface 11b of the spring 11 is a surface disposed to face the central axis A1. The inner surface 11b is formed into a flat surface. The outer surface 11c is a surface disposed on the side opposite to the inner surface 11b. The outer surface 11c is formed into a curved surface expanding outward from the contact part 10 and having a predetermined curvature (a first curvature).

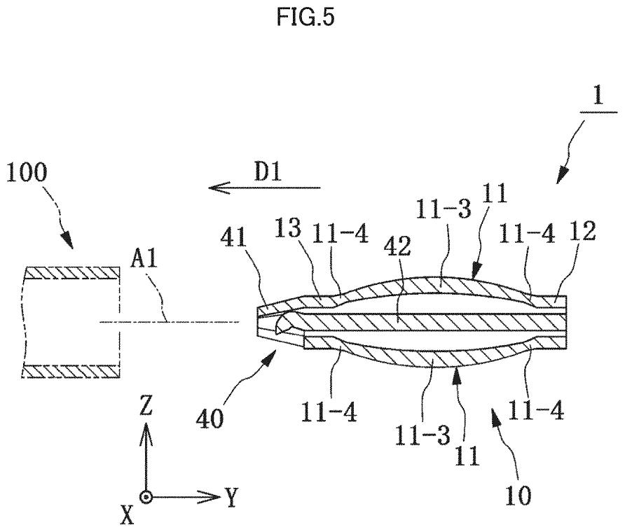

As illustrated in FIG. 5, the spring 11 is formed such that both ends 11-4 are thinner than a central portion 11-3 with respect to the direction in which central axis A1 extends. For example, in Embodiment 1, the central portion 11-3 has a plate thickness of about 0.18 mm while the both ends 11-4 have a plate thickness of about 0.15 mm.

The joint part 12 makes the four springs 11 join together and supports the springs 11 on the +Y side (opposite to the side to be inserted into the mating terminal 100). As illustrated in FIGS. 2 and 3A to 3C, the joint part 12 is formed to be annular C-shaped having a cut 14 in XZ cross section.

As illustrated in FIG. 5, the joint part 13 makes the four springs 11 join together and supports the springs 11 on the −Y side (the side to be inserted into the mating terminal 100). As illustrated in FIGS. 2 and 3A to 3C, the joint part 13 is formed to be annular C-shaped having a cut 15 in XZ cross section.

The intermediate part 20 is formed by bending the second electrically conductive plate 20a illustrated in FIGS. 4A and 4B. In Embodiment 1, the plate thickness t2 is equal to the plate thickness t3. Unlike the plate thickness t11, the plate thickness t2 of the second electrically conductive plate 20a is uniform. However, this is not restrictive and the plate thickness t2 may be uneven as with the plate thickness t11. As shown in FIGS. 3A to 3C, the intermediate part 20 is a link between the contact part 10 and the crimp part 30. The intermediate part 20 is disposed adjacent to the contact part 10 on the +Y side. The intermediate part 20 includes a tubular part 21, a lance 22, an anti-rotation projection 23, and a connection part 24.

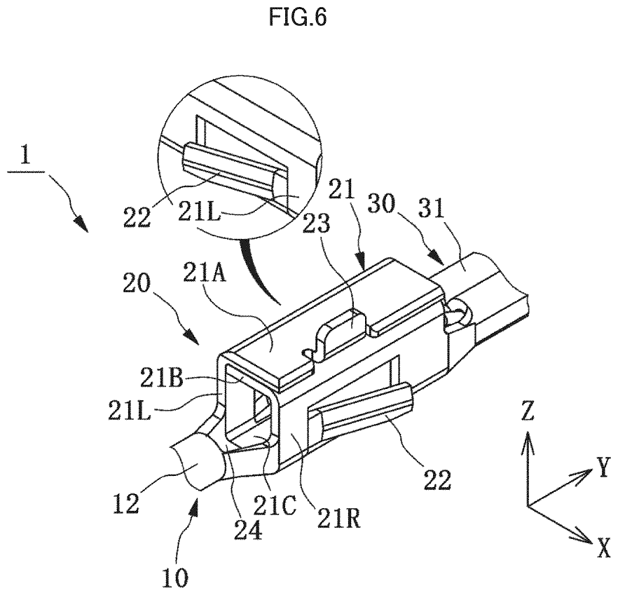

As shown in FIG. 6, the tubular part 21 is formed to be tubular to increase stiffness of the terminal 1. The tubular part 21, which includes top plates 21A and 21B, a bottom plate 21C, and side wall plates 21R and 21L, is formed by winding the second electrically conductive plate 20a (see FIGS. 4A and 4B) into a square-shaped tube. The two top plates 21A and 21B are layered.

The lance 22 is to be engaged with a lance engagement portion (a stepped portion) formed in a connector housing to hold the terminal 1 in the connector housing. The lance 22 extends from each of the side wall plates 21R and 21L of the tubular part 21. Thus, the lance 22 is formed in a cantilever manner with one end fixed on the tubular part 21 and the opposite end being a free end. In Embodiment 1, the number of the formed lances 22 is two.

The anti-rotation projection 23 is formed to project outward from the top plate 21A of the tubular part 21. The anti-rotation projection 23 serves to prevent the terminal 1 that is placed in the connector housing from rotating around the central axis A1 relative to the connector housing.

The connection part 24 connects the square-shaped tubular part 21 and the annular joint part 12.

The crimp part 30 is formed by bending the third electrically conductive plate 30a illustrated in FIGS. 4A and 4B. Unlike the plate thickness t11, the plate thickness t3 of the third electrically conductive plate 30a is uniform. However, this is not restrictive and the plate thickness t3 may be uneven as with the plate thickness t11. As illustrated in FIG. 2, the crimp part 30 includes a conductor swager 31 and a sheath holder 32. The conductor swager 31 is crimped through swaging onto, and is electrically connected with, an electrically conductive core 201 of an electric wire 200. The sheath holder 32 presses an end of an electrically insulative sheath 202 of the electric wire 200 through swaging to protect the connection between the conductor swager 31 and the core 201 from pullout force.

The insertion tip part 40, which is the tip of the terminal 1, is disposed adjacent to the contact part 10 on the side to be inserted into the mating terminal 100. The insertion tip part 40 is formed by bending the fourth electrically conductive plate 40a illustrated in FIGS. 4A and 4B. The plate thickness t4 of the fourth electrically conductive plate 40a is equal to the plate thicknesses t2 and t3. In Embodiment 1, the plate thickness t4 is 0.2 mm, for example. As illustrated in FIGS. 2 and 5, the insertion tip part 40 includes an insertion tip body 41 and a core rod 42.

The insertion tip body 41 constitutes the front edge of the terminal 1 on the −Y side. The insertion tip body 41 is tapered, that is, made gradually thinner, so as to be easily inserted into the mating terminal 100.

The core rod 42 extends from the insertion tip body 41 inside a plurality of the springs 11. The tip of the core rod 42 on the +Y side reaches the inside of the annular joint part 12. The core rod 42 is formed for the purpose of reinforcing the contact part 10. For example, during the process of fitting the terminal 1 into the mating terminal 100, when the terminal 1 is displaced with respect to the mating terminal 100 in a direction orthogonal to the central axis A1, the core rod 42 is used so that the springs 11 do not bear all the load imposed by the mating terminal 100.

The terminal 1 as configured above is produced by a method as described below.

First, a single plate 1a having a plate thickness equal to t2 or t3 as in FIGS. 4A and 4B is prepared. The plate 1a is made of an electrically conductive material. In Embodiment 1, the plate thicknesses of the plate 1a is 0.2 mm, for example.

Then, part of the plate 1a is formed into the spring forming portion 11a having the plate thickness t11, by decreasing the thickness of (that is, thinning) the spring forming portion 11a of the first electrically conductive plate 10a included in the plate 1a. In Embodiment 1, the plate thickness of the spring forming portion 11a is decreased to 0.15 to 0.18 mm. Now, the plate 1a made up of the first to fourth electrically conductive plates 10a to 40a and the carrier 50a is completed.

Next, the contact part 10 is formed by bending the first electrically conductive plate 10a. Similarly, as illustrated in FIGS. 3A to 3C, the intermediate part 20, the crimp part 30 that is not crimped onto the electric wire 200 yet, and the insertion tip part 40 are formed by bending the second, third, and fourth electrically conductive plates 20a, 30a, and 40a, respectively. The terminal 1 connected to the carrier 50a is now completed. When the user is going to use the terminal 1, the terminal 1 is disconnected from the carrier 50a as appropriate.

As described above, in Embodiment 1, the plate thickness t11 of the spring forming portion 11a is smaller than the plate thicknesses t2 and t3 of the second and third electrically conductive plates 20a and 30a as indicated in FIGS. 4A and 4B. Hence, a spring force of the spring 11 illustrated in FIG. 1 can be easily adjusted. As a result, the terminal 1 can make contact with the mating terminal 100 with higher reliability.

In Embodiment 1, the intermediate part 20 and the crimp part 30 are formed by bending the second and third electrically conductive plates 20a and 30a without decreasing the thicknesses thereof, as illustrated in FIGS. 4A and 4B. This makes it possible to easily adjust a spring force of the spring 11 illustrated in FIG. 1 while maintaining the stiffness of the terminal 1 as a whole. As a result, the terminal 1 can make contact with the mating terminal 100 with higher reliability.

In Embodiment 1, the spring 11 is formed such that the both ends 11-2 are thinner than the central portion 11-1 with respect to the circumferential direction C1, as illustrated in FIG. 3C. Hence, the central portion 11-1, which is to make contact with the mating terminal 100, has a certain thickness large enough to enable a large current to be passed while enhancing a spring force of the spring 11. As a result, the terminal 1 can make contact with the mating terminal 100 with higher reliability.

In Embodiment 1, the spring 11 is formed such that the both ends 11-4 are thinner than the central portion 11-3 with respect to the direction in which the central axis A1 extends, as illustrated in FIG. 5. Hence, the central portion 11-3, which is to make contact with the mating terminal 100, has a certain thickness large enough to enable a large current to be passed while enhancing a spring force of the spring 11. As a result, the terminal 1 can make contact with the mating terminal 100 with higher reliability.

In Embodiment 1, the central portions 11-1 and 11-3 have at least a certain thickness with respect to the circumferential direction C1 and the direction in which the central axis A1 extends, as shown in FIGS. 3C and 5. This minimizes a decrease in thickness of the first electrically conductive plate 10a intended to enhance a spring force of the spring 11, while providing a plate thickness large enough to enable a large current to be passed through the spring 11. In addition, the stiffness of the terminal 1 as a whole is not impaired.

In Embodiment 1, the intermediate part 20 includes the anti-rotation projection 23 formed to project outward from the top plate 21A as illustrated in FIG. 6. Hence, the terminal 1 in a simple structure can be prevented from rotating relative to the connector housing.

In Embodiment 1, the tubular part 21 in the intermediate part 20 is formed by winding the plate into a square-shaped tube. Hence, in comparison with, for example, a tubular part formed by winding into a cylindrical shape, the tubular part 21 in a simpler structure can prevent the terminal 1 from rotating relative to the connector housing. In Embodiment 1, the tubular part 21 is formed by winding the plate into a quadrangular tube, but this is not restrictive. The tubular part 21 may be formed into a polygonal tube other than a quadrangular tube, such as a triangular or pentagonal tube. However, from the viewpoint of preventing the terminal 1 from rotating relative to the connector housing and ease of machining into a polygon-shaped tube, the plate is preferably wound into a square-shaped tube.

In Embodiment 1, the anti-rotation projection 23 is formed on the top plate 21A of the tubular part 21 in the intermediate part 20, while the lance 22 is formed on each of the side wall plates 21R and 21L that are disposed to be contiguous with the top plate 21A. The lance 22 has the function to prevent the terminal 1 from rotating relative to the connector housing, in addition to the function to hold the terminal 1 in the connector housing. Hence, the tubular part 21 in a simple structure can prevent the terminal 1 from rotating relative to the connector housing, owing to the anti-rotation projection 23 and a pair of the lances 22 included in the tubular part 21.

Embodiment 1 of the present disclosure has been described above, but the present disclosure is not limited to Embodiment 1.

### Embodiment 2

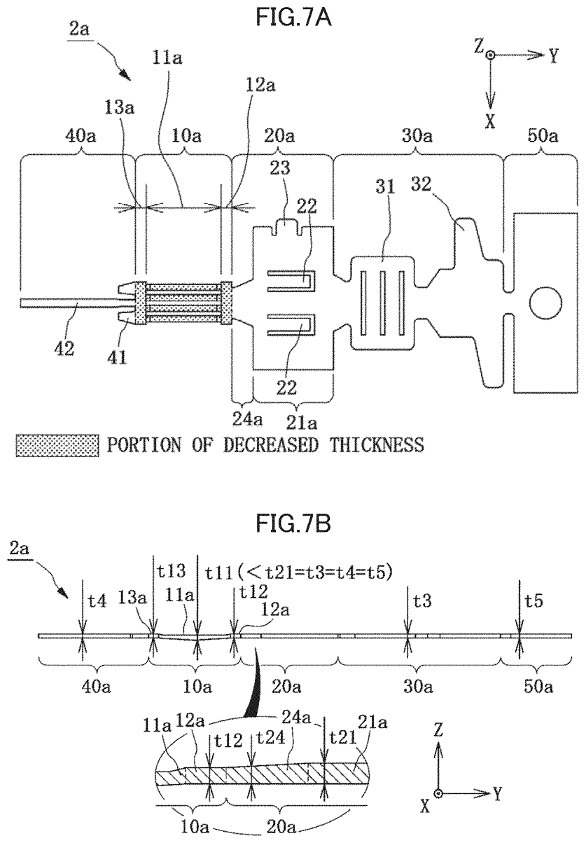

In the terminal 1 according to Embodiment 1 above, the plate thickness t11 of the spring forming portion 11a is smaller than the plate thicknesses t2 and t3 of the second and third electrically conductive plates 20a and 30a as indicated in FIGS. 4A and 4B. However, this is not restrictive. As in a plate 2a according to Embodiment 2 illustrated in FIGS. 7A and 7B, the plate thicknesses t12 and t13 of the joint part forming portions 12a and 13a, as well as the plate thickness t11 of the spring forming portion 11a, may be smaller than the plate thicknesses t2 and t3 of the second and third electrically conductive plates 20a and 30a. In other words, the plate thickness of the whole first electrically conductive plate 10a may be smaller than the plate thicknesses t2 and t3 of the second and third electrically conductive plates 20a and 30a. In Embodiment 2, the plate thicknesses t12 and t13 are each 0.15 mm, for example. As in Embodiment 1, the plate thickness t11 is 0.15 to 0.18 mm and the plate thicknesses t2 and t3 are 0.2 mm. In Embodiment 2, it is easier to roll the joint part forming portions 12a and 13a, so that the annular shape of the joint parts 12 and 13 can be approximate to a perfect circle. Note that to make it easy to adjust a spring force of the spring 11 while maintaining the stiffness of the terminal 1 as a whole, the plate thickness of the spring forming portion 11a need only be decreased, and thus the thickness of the whole first electrically conductive plate 10a may not necessarily be decreased.

In Embodiment 2, the connection part forming portion 24a, which forms the connection part 24 in the second electrically conductive plate 20a, is preferably formed such that the plate thickness t24 becomes gradually smaller toward the joint part forming portion 12a, as illustrated in FIG. 7B. In this case, the plate thickness t21 of the tubular part forming portion 21a, which forms the tubular part 21 in the second electrically conductive plate 20a, is uniform and 0.2 mm, for example. By contrast, the plate thickness t24 of the connection part forming portion 24a is uneven and becomes gradually smaller toward the joint part forming portion 12a. The plate thickness t24 at an end of the connection part forming portion 24a on the +Y side is 0.2 mm, which is equal to the plate thickness t21 of the tubular part forming portion 21a, while the plate thickness t24 at an end on the −Y side is 0.15 mm, which is equal to the plate thickness t12 of the joint part forming portion 12a. This avoids a problem of causing the contact part 10 to be inclined with respect to the central axis A1; otherwise the problem would arise when, for example, a stepped portion is created between the tubular part forming portion 21a and the connection part forming portion 24a and between the connection part forming portion 24a and the joint part forming portion 12a and the stepped portion has lower strength. Furthermore, the terminal 1 can make contact with the mating terminal 100 with higher reliability. The connection part forming portion 24a is formed by, for example, placing the plate 2a between a slanted punch and a flat die and pressing the plate 2a such that the plate thickness becomes gradually smaller from the tubular part forming portion 21a to the joint part forming portion 12a.

### Embodiment 3

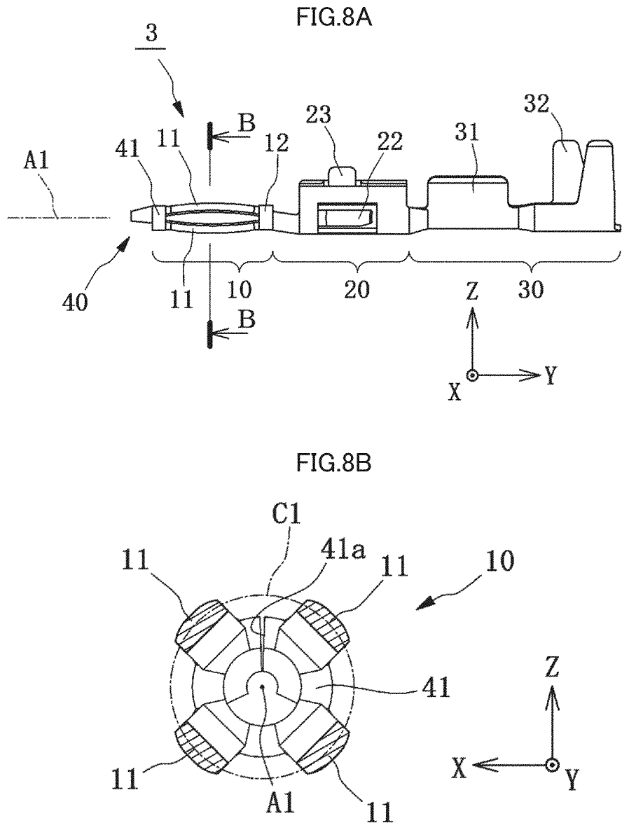

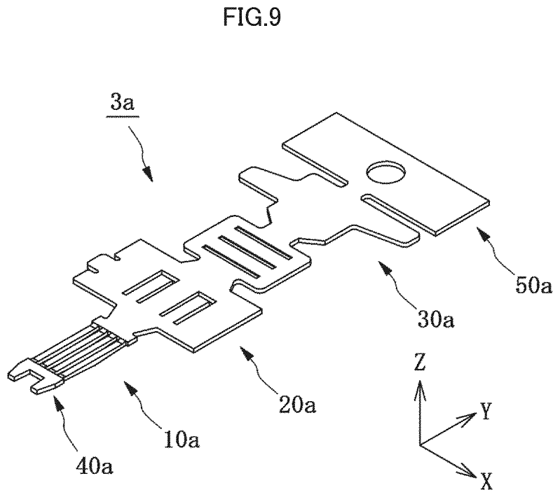

In the terminal 1 according to Embodiment 1 above, the insertion tip part 40 of the terminal 1 includes the core rod 42 as shown in FIGS. 2 and 5. However, this is not restrictive. The insertion tip part 40 may not necessarily include the core rod 42, as in the terminal 3 illustrated in FIGS. 8A and 8B. The terminal 3 is formed by bending an electrically conductive plate 3a having no portion for forming the core rod 42, as shown in FIG. 9.

### Embodiment 4

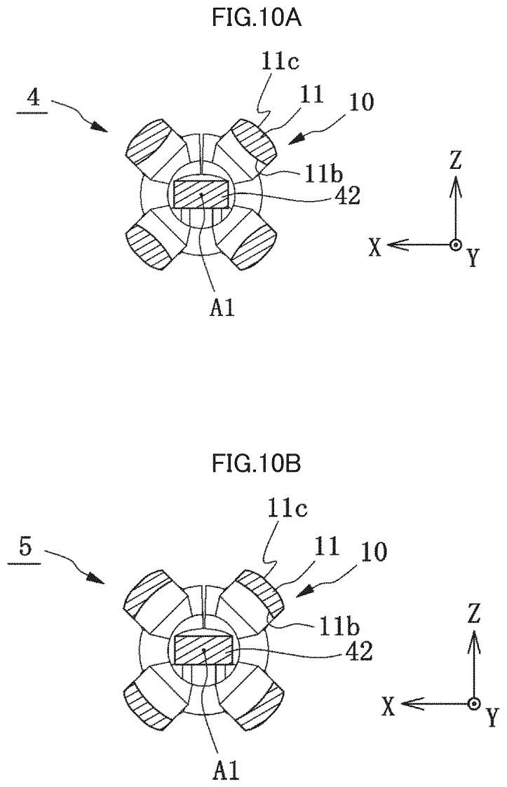

In the terminal 1 according to Embodiment 1 above, the inner surface 11b of the spring 11 is formed into a flat surface as illustrated in FIG. 3C. However, this is not restrictive. The inner surface 11b of the spring 11 may be formed into a convex surface partly expanding, as in the terminal 4 according to Embodiment 4 illustrated in FIG. 10A. For example, in Embodiment 4, the central portion of the spring has a plate thickness of about 0.18 mm while the both ends thereof have a plate thickness of about 0.10 mm with respect to the circumferential direction. In this case, the central portion, which is to make contact with the mating terminal 100, has a much greater thickness to enable a large current to be passed while enhancing a spring force of the spring 11.

### Embodiment 5

The inner surface 11b of the spring 11 may be formed into a concave surface partly dented, as in the terminal 5 according to Embodiment 5 illustrated in FIG. 10B. For example, in Embodiment 5, the central portion of the spring has a plate thickness of about 0.12 mm while the both ends thereof have a plate thickness of about 0.10 mm with respect to the circumferential direction. In this case, the central portion, which is to make contact with the mating terminal 100, still has a thickness large enough to enable a large current to be passed while enhancing a spring force of the spring 11.

### Embodiment 6

In Embodiment 5 illustrated in FIG. 10B, the inner surface 11b is formed into a curved surface having a second curvature that is approximate to the first curvature of the outer surface 11c. However, this is not restrictive. As in the terminal 6 according to Embodiment 6 illustrated in FIG. 10C, the inner surface 11b may be formed into a curved surface having a second curvature that represents a less steeper curve than the first curvature of the outer surface 11c. For example, in Embodiment 6, the central portion of the spring has a plate thickness of about 0.15 mm while the both ends thereof have a plate thickness of about 0.10 mm with respect to the circumferential direction. The outer surface 11c formed into a sharper curve than the inner surface 11b can enhance the ability to make contact with the mating terminal 100. Note that the inner surface 11b and the outer surface 11c may not necessarily have a uniform radius of curvature.

### Other Embodiments

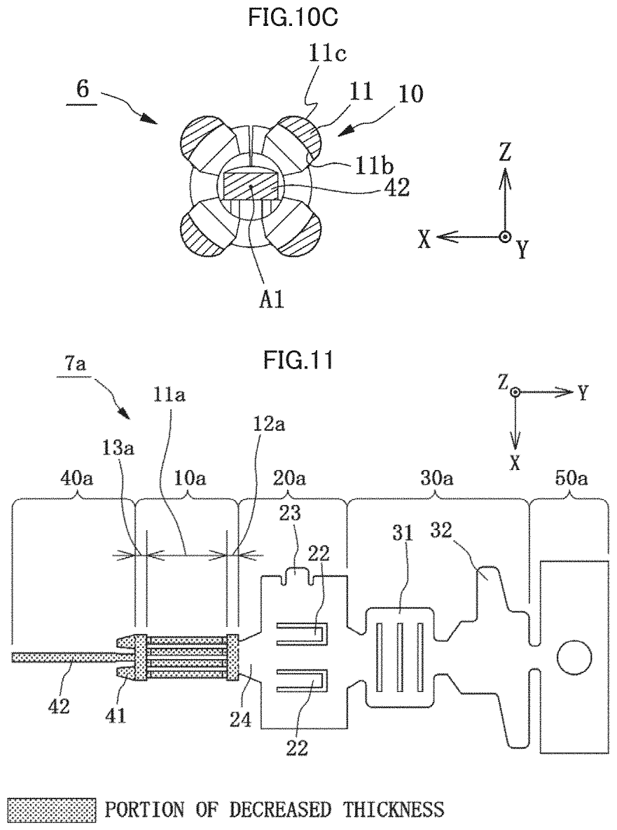

In Embodiment 2 above, the plate thickness is decreased in a portion of the plate 2a, the portion corresponding to the first electrically conductive plate 10a. However, this is not restrictive. For example, as in the plate 7a according to Embodiment 7 illustrated in FIG. 11, not only the first electrically conductive plate 10a but also the fourth electrically conductive plate 40a may be decreased in plate thickness. For example, in Embodiment 7, the plate thickness of the spring forming portion 11a is 0.15 to 0.18 mm while the plate thickness of the joint part forming portions 12a and 13a is 0.15 mm. The plate thicknesses of the second and third electrically conductive plates 20a and 30a are each 0.2 mm. The plate thickness of a portion of the fourth electrically conductive plate 40a corresponding to the insertion tip body 41 is 0.15 mm and the plate thickness of a portion corresponding to the core rod 42 is 0.15 mm. In this case, the fourth electrically conductive plate 40a is easier to bend, and thus the insertion tip part 40 can be easily formed. In addition, the thinner fourth electrically conductive plate 40a is easier to roll. Thus, in comparison with a thicker plate, the electrically conductive plate can be rolled into a shape having a smaller diameter and the core rod 42 can be made thinner, which makes the joint part 12 disposed around the tip of the core rod 42 smaller in diameter. The plate thickness of a portion corresponding to the insertion tip body 41 may be gradually smaller from the joint part forming portion 13a to the −Y side. In this case, the plate thickness of a portion corresponding to the insertion tip body 41 is 0.10 to 0.15 mm.

In Embodiment 1 above, the first to fourth electrically conductive plates 10a to 40a are formed of a single plate 1a. However, this is not restrictive. Each of the first to fourth electrically conductive plates 10a to 40a may be a separate plate, or at least one or two of the first to fourth electrically conductive plates 10a to 40a may be a separate plate.

In the terminal 1 according to Embodiment 1 above, the number of the springs 11 in the contact part 10 is four. However, this is not restrictive. The number of the springs 11 may be other than four. For example, the number of the springs 11 may be three. However, from the viewpoint of the reliability with which the terminal 1 makes contact with the mating terminal 100, the number of the springs 11 is preferably four.

In the terminal 1 according to Embodiment 1 above, two lances 22 extend from the tubular part 21. However, this is not restrictive. The number of the lances 22 extending from the tubular part 21 may be other than two. However, from the viewpoint of holding the terminal 1 in the connector housing, it is preferable that two lances 22 extend from the tubular part 21.

In the terminal 1 according to Embodiment 1 above, the intermediate part 20 includes a single anti-rotation projection 23. However, this is not restrictive. The intermediate part 20 may include two or more anti-rotation projections 23. This further enhances the anti-rotation effect of inhibiting the terminal 1 from rotating relative to the connector housing.

Numerical values of plate thicknesses of portions of the plate 1a, 2a, 3a, or 7a in the terminal 1, 3, 4, 5, or 6 in Embodiments 1 to 7 above are provided as examples only and plate thicknesses are not limited thereto. The plate thicknesses may be changed as appropriate depending on the size of the terminal, the mating terminal, and the housing.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure can be applied to an electrical connector used as a component of an electrical circuit.

What is claimed is:

1. A terminal having a central axis parallel to a direction in which the terminal is inserted into a mating terminal, the terminal comprising:
a contact part comprising: a plurality of springs that makes contact with the mating terminal and are equally spaced along a circumferential direction around the central axis; and a first joint part that makes the plurality of the springs join together, the contact part being formed by bending a first electrically conductive plate; and
a body part comprising a tubular part formed to be tubular, the body part being disposed adjacent to the contact part and formed by bending a second electrically conductive plate,
wherein a plate thickness of a spring forming portion of the first electrically conductive plate, the spring forming portion forming the springs, is smaller than the plate thickness of a tubular part forming portion of the second electrically conductive plate, the tubular part forming portion forming the tubular part.

2. The terminal according to claim 1, wherein the contact part comprises a second joint part that makes the plurality of the springs join together at an insertion side to be inserted into the mating terminal, and wherein the first joint part makes the plurality of the springs join together at a side opposite to the insertion side.

3. The terminal according to claim 2, wherein the plate thicknesses of a first joint part forming portion forming the first joint part and a second joint part forming portion forming the second joint part in the first electrically conductive plate are smaller than the plate thickness of the second electrically conducive plate.

4. The terminal according to claim 3, wherein the body part comprises a connection part connecting the tubular part and the first joint part forming portion, and wherein a connection part forming portion forming the connection part in the second electrically conductive plate is formed such that the plate thickness of the connection part forming portion becomes gradually smaller toward the first joint part forming portion.

5. The terminal according to claim 2, wherein the plate thicknesses of a first joint part forming portion forming the first joint part and a second joint part forming portion forming the second joint part in the first electrically conductive plate are equal to the plate thickness of the second electrically conducive plate.

6. The terminal according to claim 1, comprising:
a conductor fixing part that is formed by bending a third electrically conductive plate and is to be connected to a conductor to bring the conductor into electrical conduction with the mating terminal, wherein the plate thickness of the spring forming portion is smaller than the plate thickness of the third electrically conductive plate.

7. The terminal according to claim 1, comprising:
an insertion tip part disposed adjacent to the contact part at an insertion side to be inserted into the mating terminal, the insertion tip part being formed by bending a fourth electrically conductive plate.

8. The terminal according to claim 7, wherein the plate thickness of the fourth electrically conductive plate is smaller than the plate thickness of the second electrically conductive plate.

9. The terminal according to claim 7, wherein the plate thickness of the fourth electrically conductive plate is equal to the plate thickness of the second electrically conductive plate.

10. The terminal according to claim 7, wherein the insertion tip part comprises a core rod extending inside the plurality of the springs.

11. The terminal according to claim 1, wherein the first electrically conductive plate and the second electrically conductive plate are formed of a single plate.

12. The terminal according to claim 1, wherein the spring is formed such that both ends of the spring are thinner than a central portion of the spring with respect to the circumferential direction.

13. The terminal according to claim 12, wherein the spring comprises an inner surface disposed to face the central axis, and wherein the inner surface is formed into a flat surface.

14. The terminal according to claim 12, wherein the spring comprises an inner surface disposed to face the central axis, and wherein the inner surface is formed into a convex surface partly expanding.

15. The terminal according to claim 12, wherein the spring comprises an inner surface disposed to face the central axis, and wherein the inner surface is formed to be a concave surface partly dented.

16. The terminal according to claim 15, wherein the spring comprises an outer surface that is disposed on a side opposite to the inner surface and formed into a curved surface expanding outward from the contact part and having a first curvature, and wherein the inner surface is formed into a curved surface having a second curvature representing a less steeper curve than the first curvature.

17. The terminal according to claim 1, wherein the spring is formed such that both ends of the spring are thinner than a central portion of the spring with respect to a direction in which the central axis extends.

18. The terminal according to claim 1, wherein the body part comprises a cantilevered lance extending from the tubular part.

19. The terminal according to claim 18, wherein the tubular part is formed by winding the second electrically conductive plate into a square-shaped tube.

20. A method for producing a terminal having a central axis parallel to a direction in which the terminal is inserted into a mating terminal, the terminal comprising: a contact part comprising a plurality of springs that makes contact with the mating terminal and are equally spaced along a circumferential direction around the central axis, the contact part being formed by bending a first electrically conductive plate; and a body part comprising a tubular part formed to be tubular, the body part being disposed adjacent to the contact part and formed by bending a second electrically conductive plate, the method comprising the steps of:
preparing a plate having a plate thickness equal to the plate thickness of the second electrically conductive plate;
forming the first electrically conductive plate by decreasing the plate thickness of a spring forming portion of the plate, the spring forming portion forming the spring; and
forming the contact part by bending the first electrically conductive plate.
